(19) United States
(12) Patent Application Publication
(10) Pub. No.: US 2014/0164024 A1
(43) Pub. Date: Jun. 12, 2014

(54) SYSTEM AND METHOD FOR ENHANCED INSURANCE SELECTION

(71) Applicant: METROPOLITAN LIFE INSURANCE CO., New York, NY (US)

(72) Inventors: Phillip Scone, Leicester (GB); James Moore, Loughborough (GB)

(73) Assignee: METROPOLITAN LIFE INSURANCE CO., New York, NY (US)

(21) Appl. No.: 13/711,157

(22) Filed: Dec. 11, 2012

(51) Int. Cl. G06Q 40/08

(52) U.S. Cl. CPC G06Q 40/08
USPC 705/4

(57) ABSTRACT

Disclosed is a system and computer based method to provide an intuitive interface that educates users about risk management needs, and/or assists users in selecting proper risk management instruments. In a preferred embodiment, the system include a tool that allows customers to easily plan for key events in life, such as buying a home, starting a family, educating their kids, retiring; exposes customers to some of the risks in life, such as health problems, accidents, income loss and unexpected costs; and provides risk management product recommendations and personal quotes.

### BACKGROUND

Insurance products protect customers against various risks. For example, disability insurance can supplement a policyholder's income when their ability to earn wages is lost or diminished due to illness or injury. Life insurance can protect a policyholder and his or her family against the loss of the policyholder's financial contributions after the policyholder has passed away. Home insurance can protect a homeowner against losses due to burglaries, floods and fires.

Effectively selecting insurance, however, is a difficult process because of the various events that may occur over the consumer's lifetime. For example, an individual must consider whether and when they will buy a home, start a family, educate their children, face increasing medical expenses, and prepare to retire. Not only does each of these life events reflect a risk, all are better addressed by adequate planning.

Therefore, there is a need for an effective means of providing an intuitive interface that assists users in selecting proper risk management instruments.

### BRIEF DESCRIPTION OF THE DRAWINGS

FIG. 1 illustrates the environment of the disclosed technology in accordance with one embodiment.

FIG. 2 illustrates the process flow of the disclosed technology in accordance with one embodiment.

FIGS. 3-12 are illustrative screenshots of the present invention according to certain embodiments.

### DETAILED DESCRIPTION

The present invention provides a data-processing system and computer-based method to intuitively assist participants to become policyholders by selecting proper risk management instruments. In certain embodiments, the system include a tool that: 1) allows customers to easily plan for key events in life, such as buying a home, starting a family, educating their kids, retiring; 2) exposes customers to some of the risks in life, such as health problems, accidents, income loss and unexpected costs; and 3) provides product recommendations and personal quotes. In certain embodiments, instead of specific product recommendations, the tool provides coverage recommendations; for example, the suggested amount of coverage needed to protect against certain risks. In certain embodiments, instead of personal quotes, the tool provides generalized estimations of costs.

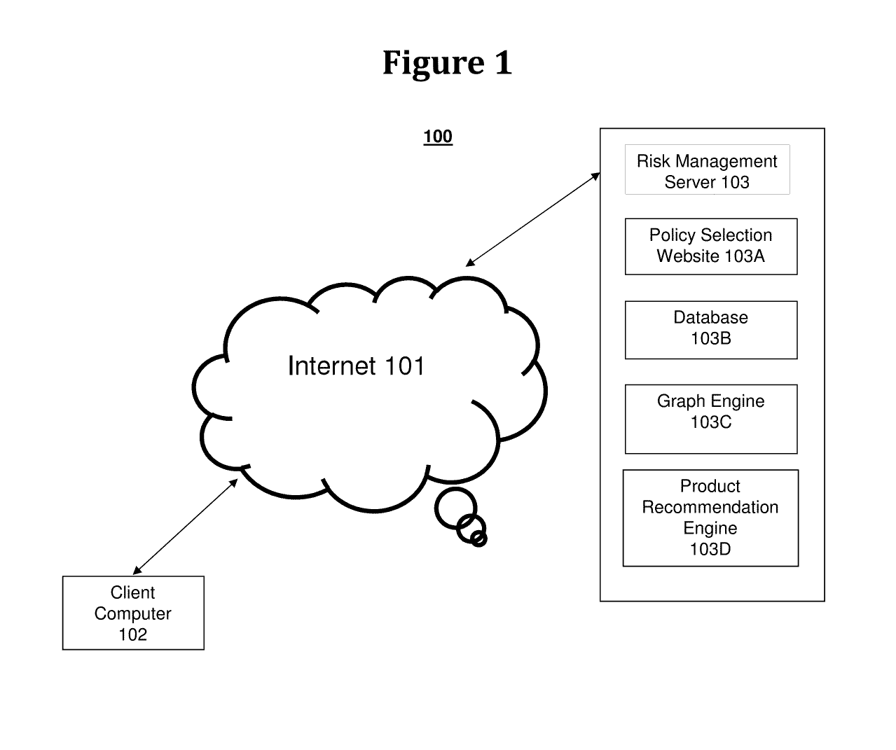

FIG. 1 illustrates an embodiment of the presently disclosed system for educating a customer about risk management needs, and optionally assisting a customer with selecting insurance, savings and/or investment products. System 100 includes Client Computer 102 operated by an insurance customer, and Risk Management Server 103 operated by an insurance company. Risk Management Server 103 includes Policy Selection Website 103A for providing a graphical user interface to the customer, Database 103B containing insurance related actuarial information, Graph Engine 103C for generating graphs indicating a customer's expected savings over time, and Product Recommendation Engine 103D for recommending insurance, savings and investment products to the customer. Client Computer 102 is able to access Policy Selection Website 103A via Internet 101. At Policy Selection Website 103A, the customer may be presented with animations used to simplify the insurance and savings planning process. Additionally, the Policy Selection Website 103A is used to receive information from Client Computer 102, such as customer goals, and present information to Client Computer 102, such as data relating to unexpected events.

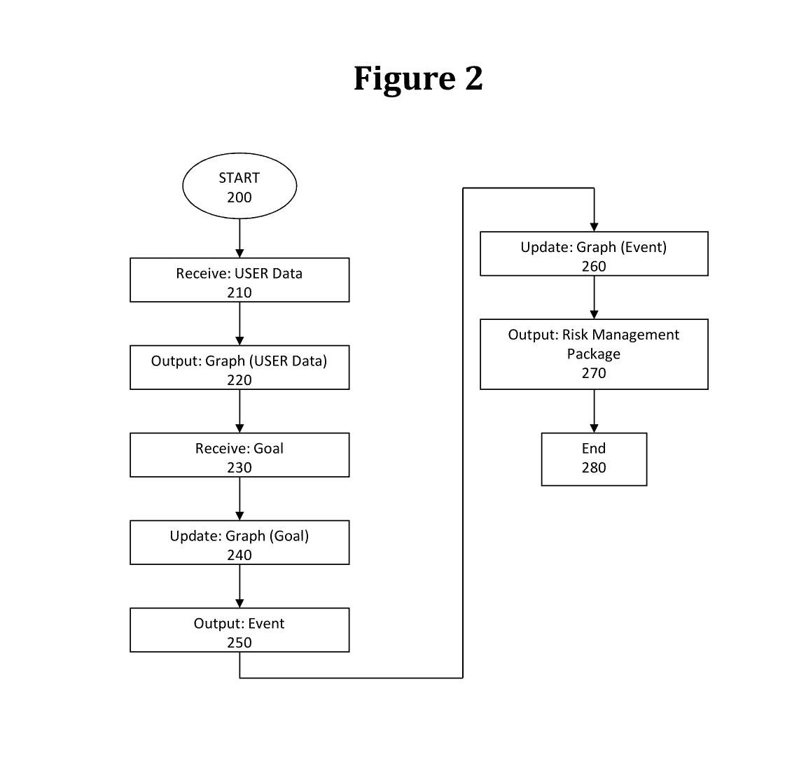

FIG. 2 is a flow chart of the process flow of the disclosed technology in accordance with one embodiment. The process starts at 200 and proceeds to 210, where the system receives USER Data. The USER Data is used to output a Graph of the user's total savings (for example, liquid assets saved minus debt) over time at 220. The system then receives a Goal from the user at 230. For example, a Goal may be to buy a house when the user is 40 years old. The Graph is updated with the Goal information at 240. If the user's Goal house, for example, is estimated to cost $250,000, then that amount will be deducted from the user's savings chart at the age of 40. The system outputs an unexpected hypothetical Event at 250, such as a heart attack when the user is 35 years old. The system may also present the user with data related to the unexpected event, such as the statistics in the user's region for heart attacks for 35 year olds. The system then updates the Graph based on the Event at 260. For example, if a heart attack is expected to cost the user $200,000 (hospital bills, lost wages, etc), then that amount is deducted from the user's savings at the appropriate location in the Graph timeline. A Risk Management Package is output at 270. This package may include one or more insurance products to mitigate a user's risk (for example, based on the unexpected Events). The package may also include savings and investment products to help the user reach his or her Goals, for example, buying a house. The process ends at 280.

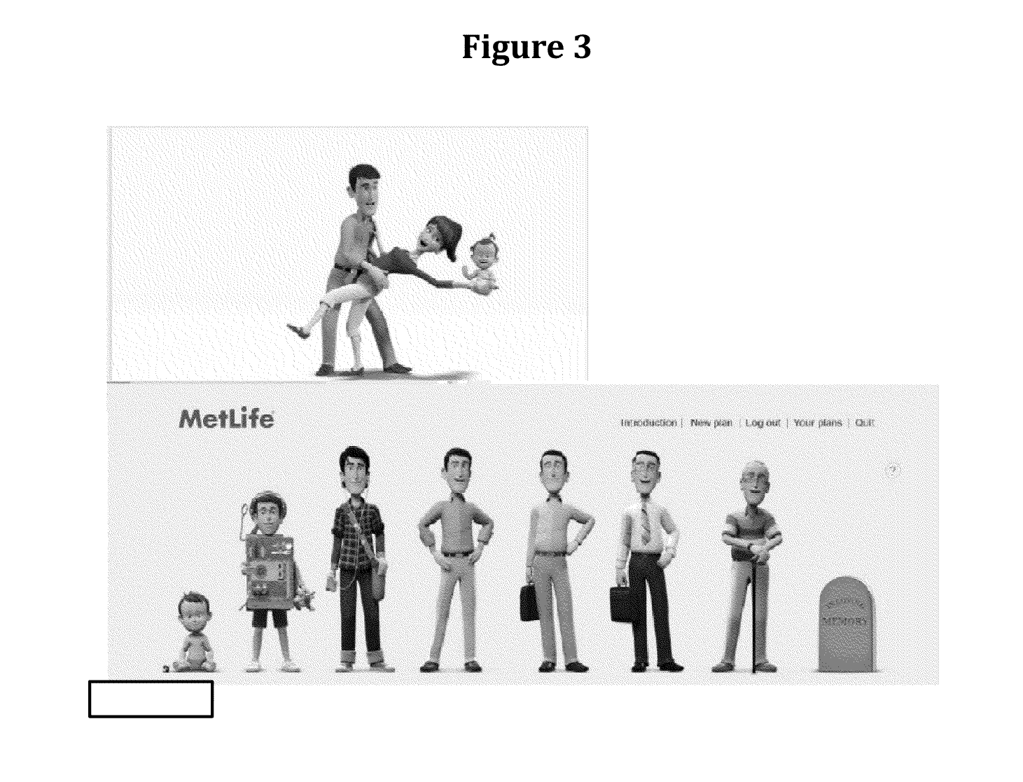

In one embodiment, users are presented with a video or animation showing a happy version of a character's life. For example, the life of a cartoon character, Dave, is shown in FIG. 3, including key events in his life such as going to college, getting married, having a family, and retiring. Users are then invited to explore “what if” Dave's life was not so happy, by playing with Dave's “disasters” and seeing how those disasters affect his family's finances. Users are able to make simple adjustments to make the plan their own, and are presented with their own “what ifs.” In one embodiment, the system presents a personalized model and plan to the user. In another embodiment, only a generalized model and plan, such as Dave's plan, are presented to the user. These various embodiments may be employed through software modules, and the level of personalization may be customized to varying degrees. Such a feature allows for compliance with the laws of certain jurisdictions.

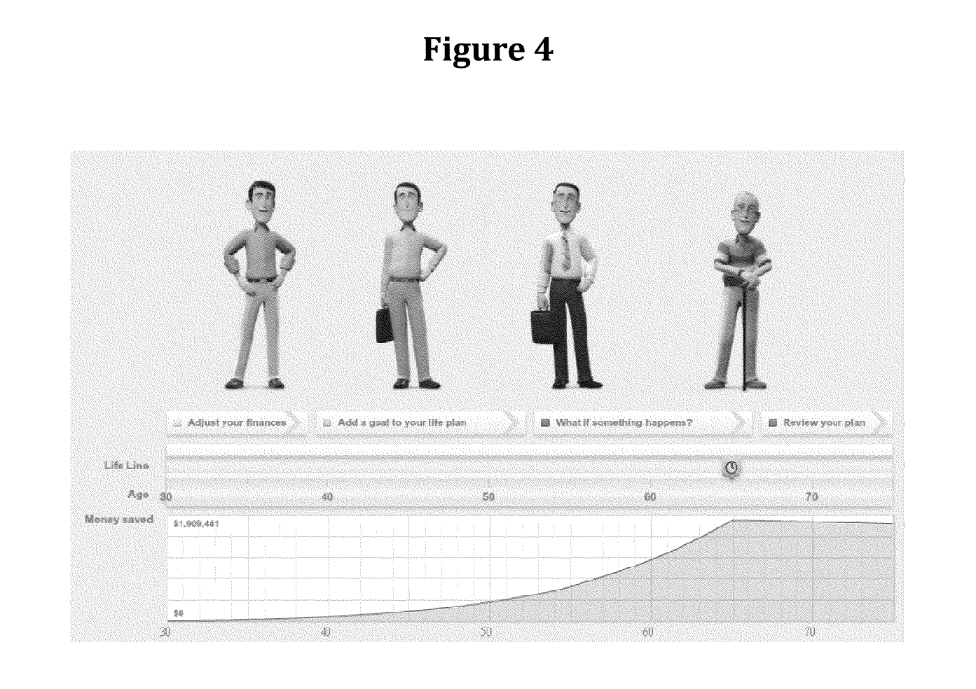

FIG. 4 is a screenshot showing the amount of money Dave has accumulated during his life. This screen also allows the user to adjust Dave's finances to their own, add goals to their life plan, see the effect of “what ifs,” and review their plan.

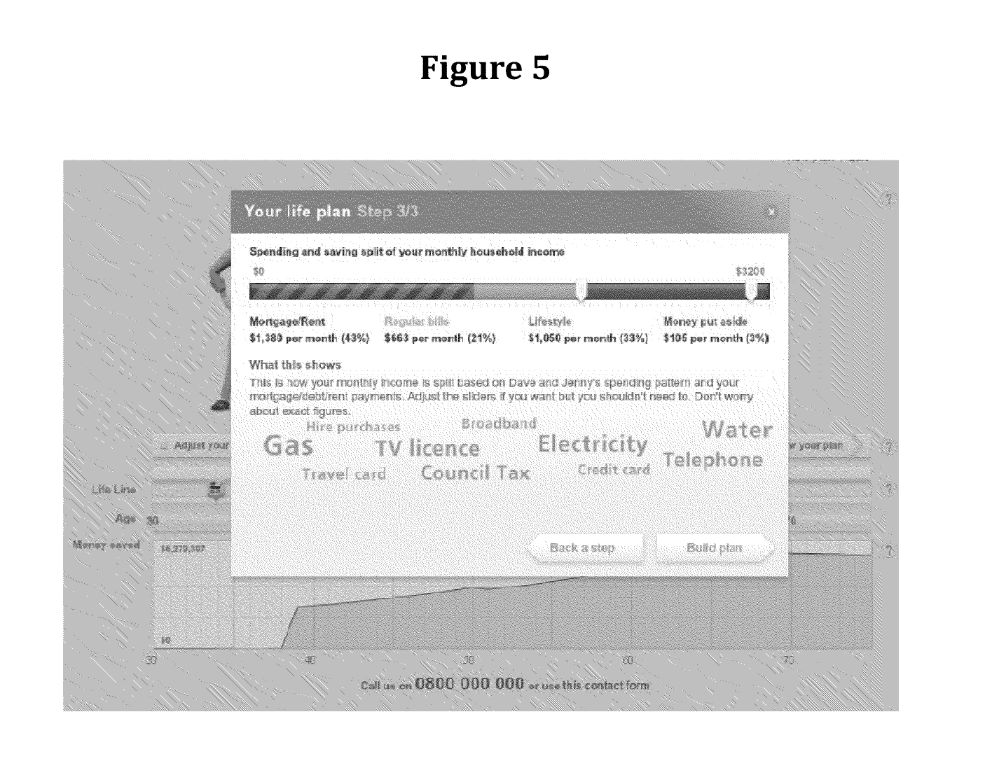

FIG. 5 illustrates a user adjusting their finances. For example, the user is able to enter their mortgage/rent, bills, lifestyle costs, and savings per month. In this example, Dave's default amounts are shown, and the user adjusts the default amounts to their own. In another embodiment, default amounts may be based on information known about the user, such as sex or location.

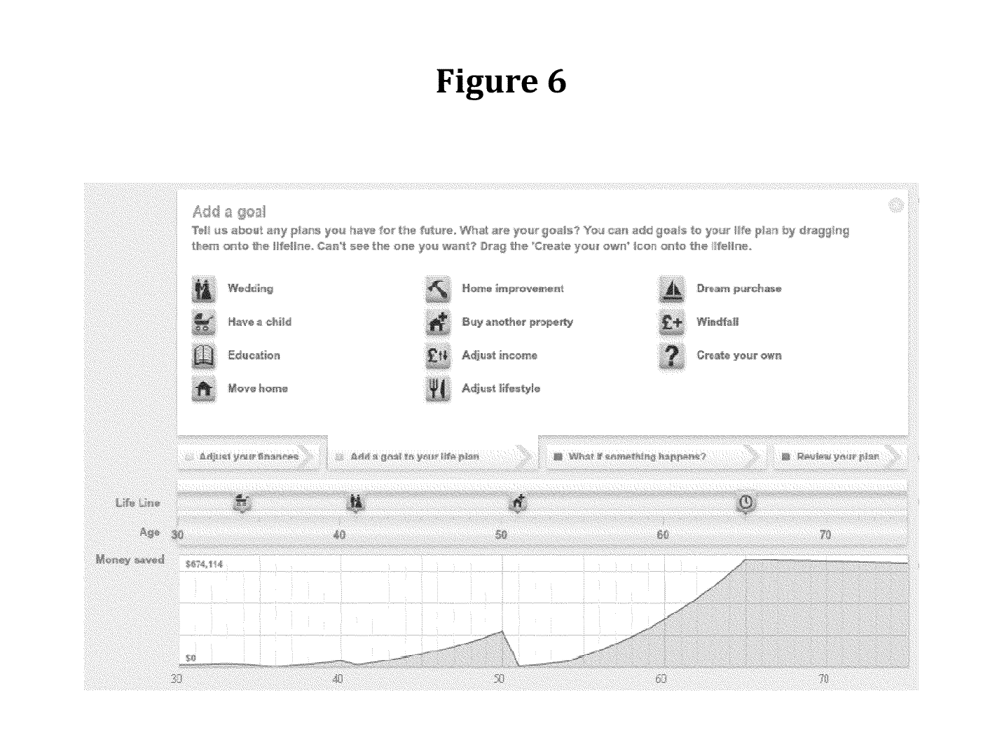

A user is able to add goals, as shown in FIG. 6, such as weddings, having a child, education, moving homes, home improvements, buying property, adjusting income, adjusting lifestyles, dream purchases (such as boats), windfalls, or defining their own goal. The goals are added to a particular point on the “lifeline.” For example, a user may wish to have a child when she is 35 years old, and so the user will drag the “have a child” icon on to the lifeline where the x-axis is 35. When a user selects or drags one of these goals on to the lifeline, additional options will be presented. For example, default costs associated with having a child may be shown, and the user, in one embodiment, is able to change those default costs and/or assumptions. As goals are dragged on to the lifeline, the net worth or money saved chart will be adjusted. For example, if, based on the user's finance settings, the money saved chart shows that the user will save $50,000 by the time the user is 40 years old, and the user sets a goal of buying a $10,000 boat when he is 40 years old, the money saved chart will be adjusted down by $10,000 at the 40 years old mark on the graph. These adjustments will affect future money saved amounts as well. For example, if the user finance section assumes that the user will be earning 5% interest on money saved, the user will not gain the 5% interest on the $10,000 spent on the boat after the purchase at age 40.

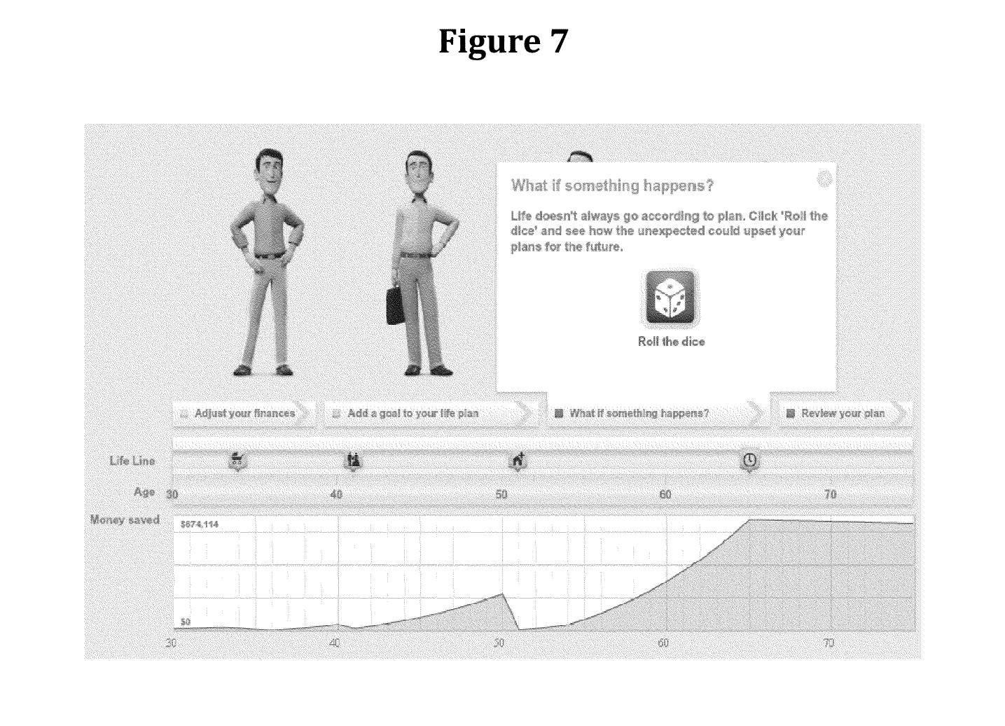

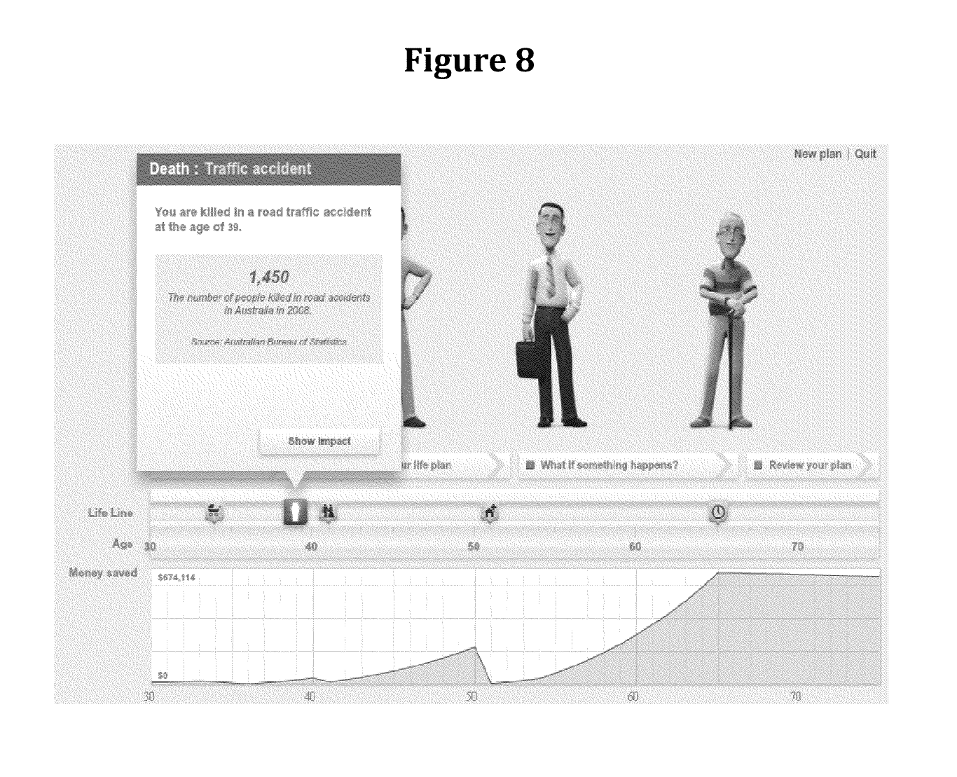

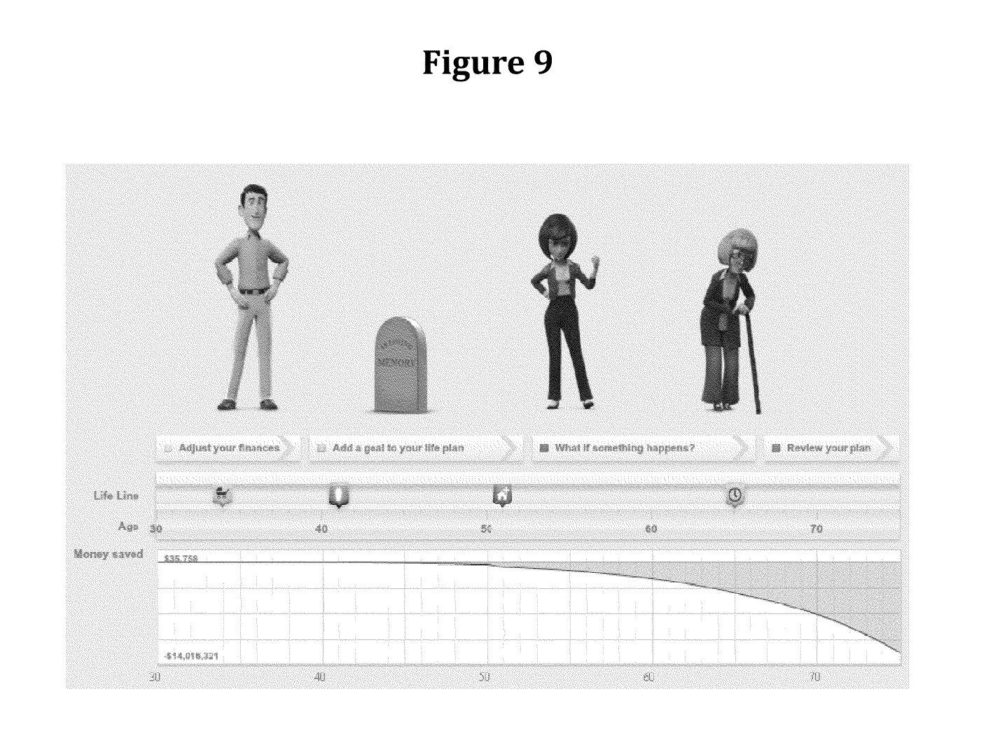

Users are also able to add “what if” events, and see how those events affect the user's savings. FIG. 7 illustrates a “Roll the Dice” button that incorporates a random negative event into the user's lifeline. For example, in FIG. 8, after a user clicks the Roll the Dice button, the system presents the hypothetical situation that the user is killed in a traffic accident at the age of 39. The screen also displays relevant facts for this random event, such as the number of people killed by that event in the user's location. Those skilled in the art understand that any number of negative events can be used in place of a traffic accident, such as a heart attack, stroke, loss of job, etc. In one embodiment, the user is able to select the specific negative event. The system then applies the negative event to the user's money saved chart, in FIG. 9, and shows the effect on future savings for the user and his or her family.

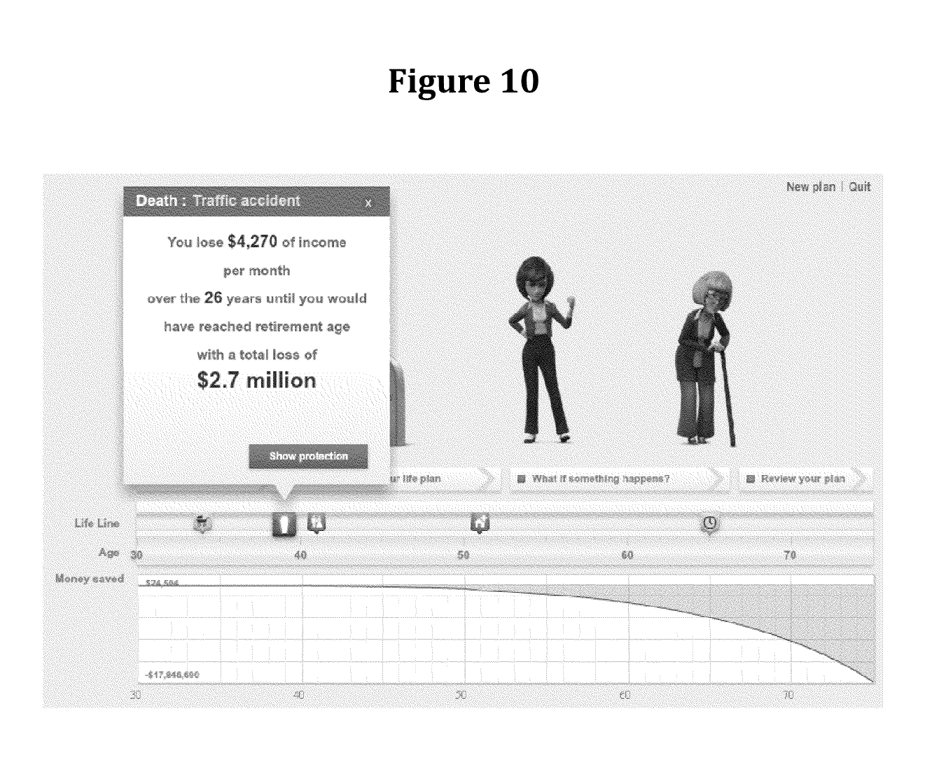

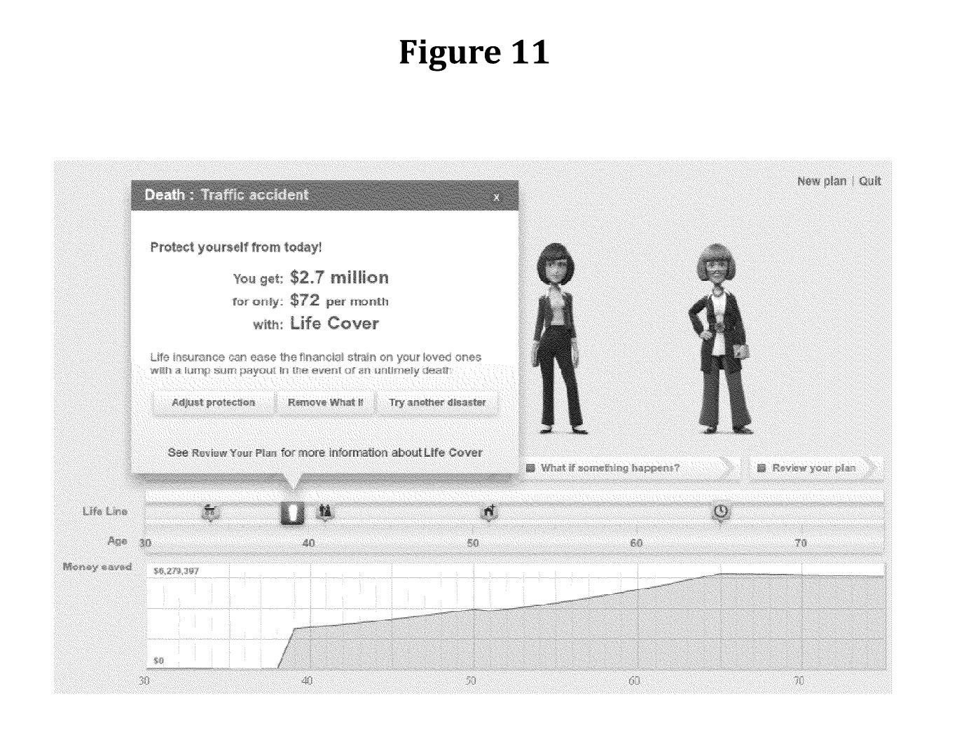

In FIG. 10, the system displays a box indicating that the user's death will result in a loss of $4,270 of income per month over the 26 years until the user would have reached retirement age, with a total loss of $2.7 million. The system also shows the effect the event and related loss of income will have on the user's family's savings. Along with the indication of the effects of the negative result, the user is presented with an option to show protection plans for such an event. Upon selecting the show protection option, in FIG. 11, the user is presented with an insurance plan with a face value of $2.7 million (enough to cover the expected loss), along with the monthly premium associated with the insurance plan. The user may adjust the parameters associated with the insurance plan, for example, lower the amount of coverage, and the system will update the monthly premium payments accordingly as well as the money saved chart. The user may also remove the negative event and/or try another random negative event.

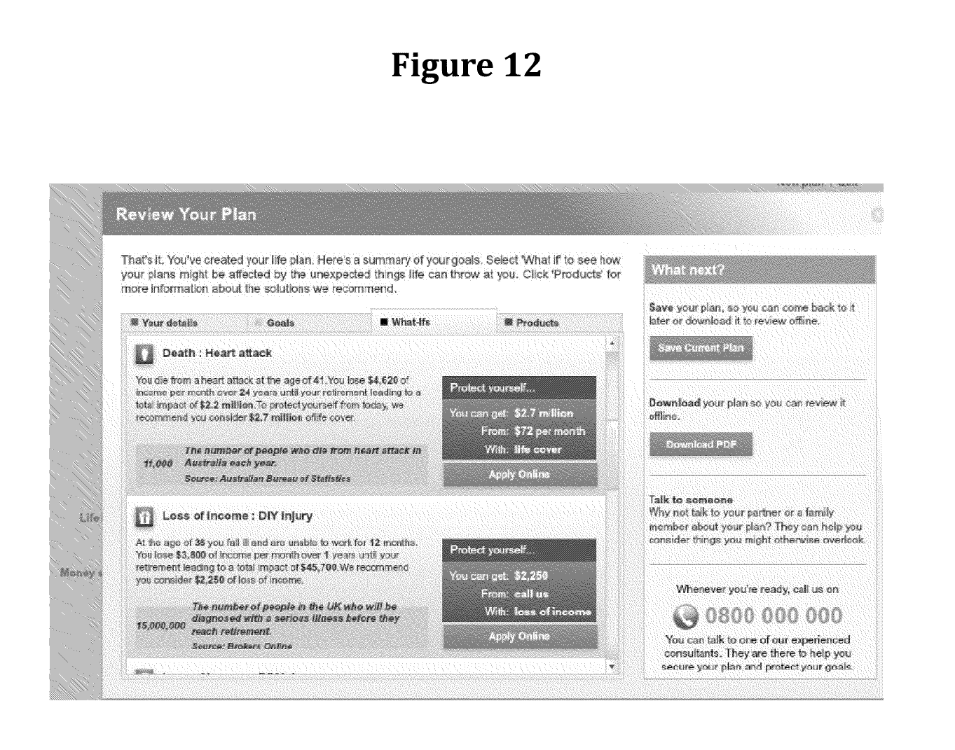

In FIG. 12, the user is presented with the option to review a risk management plan. The “what if” tab shows summaries of possible negative scenarios, such as a heart attack or loss of income due to an injury. It also shows the effect of those negative scenarios and information about their likelihood. For example, the amount of monthly and total income loss to the user, and the statistics relating to the negative event for the user's region. The user is also presented with summaries of the insurance options recommended to reduce the risk associated with those negative events. For example, the user is presented with the hypothetical negative event that at the age of 36, he or she will fall ill and be unable to work for 12 months, causing a loss of monthly income of $3,800 and a total loss of $45,700. Additionally, the system presents the statistic that in the United Kingdom, 15 million people will be diagnosed with a serious illness before they reach retirement. The system recommends coverage of $2,250 per month for the user to protect against loss of income due to injury, and presents the estimated monthly premium amount for such coverage. Likewise, the system presents the same information for other negative events, such as a heart attack or permanent disablement. The user is able to download their current plan to their computer so she can review it offline, save the current plan on the website so she can review and customize it later, and/or talk to a representative. The representative may be contacted by either dialing the number provided, or simply clicking on a button that will initiate a web-based chat or request that the insurance company call the user.

In addition to the “what if” scenarios, some embodiments of the review risk management plan feature can show the user summaries of family finances, goals, and products. The family finances can include the user and user's partners: ages, incomes, retirement plans (for example, a user may wish to retire at the age of 65 on 50% of their previous income), monthly household income, tax considerations, rent, debt repayments, bills, lifestyle (entertainment, etc.), and money saved. The goals summary will include the goals the user added with the add goals tool shown in FIG. 6, and will include the cost associated with each goal. This summary will also provide the user with savings and investment plan options designed to help the user reach those goals. The products tab shows detailed summaries of the insurance, savings and investment plans recommended in the goals and “what if” tabs.

The invention described above is operational with general purpose or special purpose computing system environments or configurations. Examples of well known computing systems, environments, and/or configurations that may be suitable for use with the invention include, but are not limited to: personal computers, server computers, hand-held or laptop devices, smart phones such as iPhones™, tablet devices such as iPads™, multiprocessor systems, microprocessor-based systems, set top boxes, programmable consumer electronics, network PCs, minicomputers, mainframe computers, distributed computing environments that include any of the above systems or devices, and the like.

Components of the inventive computer system may include, but are not limited to, a processing unit, a system memory, and a system bus that couples various system components including the system memory to the processing unit.

The computer system typically includes a variety of non-transitory computer-readable media. Computer-readable media can be any available media that can be accessed by the computer and includes both volatile and nonvolatile media, and removable and non-removable media. By way of example, and not limitation, computer-readable media may comprise computer storage media and communication media. Computer storage media may store information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The computer system may operate in a networked environment using logical connections to one or more remote computers. The remote computer may be a personal computer, a server, a router, a network PC, a peer device or other common network node, and typically includes many or all of the elements described above relative to the computer. The logical connections depicted in include one or more local area networks (LAN) and one or more wide area networks (WAN), but may also include other networks. Such networking environments are commonplace in offices, enterprise-wide computer networks, intranets and the Internet.

For ease of exposition, not every step or element of the present invention is described herein as part of software or computer system, but those skilled in the art will recognize that each step or element may have a corresponding computer system or software component. Such computer systems and/or software components are therefore enabled by describing their corresponding steps or elements (that is, their functionality), and are within the scope of the present invention. In addition, various steps and/or elements of the present invention may be stored in a non-transitory storage medium, and selectively executed by a processor.

The foregoing components of the present invention described as making up the various elements of the invention are intended to be illustrative and not restrictive. Many suitable components that would perform the same or similar functions as the components described are intended to be embraced within the scope of the invention. Such other components can include, for example, components developed after the development of the present invention.

1. A computer-implemented method, comprising:
receiving at a server, via a distributed network, a user's personal information;
outputting, via said distributed network, a graph indicating said user's estimated total savings over time;
receiving, via the distributed network, a goal of said user and a date associated with said goal;
updating, via a processor operatively coupled to said server, said graph based on said goal and said date associated with said goal;
outputting, via said distributed network, data associated with an unexpected event, said data comprising a predicted cost associated with the unexpected event;
updating, via said processor, said graph based on said data associated with said unexpected event; and
outputting, via said distributed network, a risk management package recommended to protect said user against one or more unexpected risks.

2. The computer-implemented method of claim 1, wherein said data associated with said unexpected event further comprises statistics relating to the occurrence of the event.

3. The computer-implemented method of claim 1, wherein said risk management package comprises at least one life insurance policy.

4. The computer-implemented method of claim 1, further comprising the step of outputting, via said distributed network, a savings or investment package to aid the user in reaching said goal.

5. The computer-implemented method of claim 1, wherein said user's personal information comprises financial information.

6. The computer-implemented method of claim 1, wherein the total amount saved by the user over time includes the total amount saved by the user's family.

7. The computer-implemented method of claim 1, wherein said user refers to the user and the user's family.

8. The computer-implemented method of claim 1, wherein said graph includes estimates of income increases.

9. The computer-implemented method of claim 1, wherein said goal is selected from a list consisting of: wedding, child, college, moving homes, home improvement, buying property, adjusting income, adjusting lifestyle, dream purchase, windfall, and user-defined goal.

10. A system comprising:
a server comprising a data processor programmed to:
receive at the server, via a distributed network, a user's personal information;
output, via said distributed network, a graph indicating said user's estimated total savings over time;
receive, via the distributed network, a goal of said user and a date associated with said goal;
update said graph based on said goal and said date associated with said goal;
output, via said distributed network, data associated with an unexpected event, said data comprising a predicted cost associated with the unexpected event;
update said graph based on said data associated with said unexpected event; and
output, via said distributed network, a risk management package recommended to protect said user against one or more unexpected risks.

11. The system of claim 10, wherein said data associated with said unexpected event further comprises statistics relating to the occurrence of the event.

12. The system of claim 10, wherein said risk management package comprises at least one life insurance policy.

13. The system of claim 10, wherein said data processor is further programmed to output, via said distributed network, a savings or investment package to aid the user in reaching said goal.

14. The system of claim 10, wherein said user's personal information comprises financial information.

15. The system of claim 10, wherein the total amount saved by the user over time includes the total amount saved by the user's family.

16. The system of claim 10, wherein said user refers to the user and the user's family.

17. The system of claim 10, wherein said graph includes estimates of income increases.

18. The system of claim 10, wherein said goal is selected from a list consisting of: wedding, child, college, moving homes, home improvement, buying property, adjusting income, adjusting lifestyle, dream purchase, windfall, and user-defined goal.

19. A non-transitory computer-readable storage medium with an executable program stored thereon, wherein the program instructs a data processor to perform the following steps:
receive at a server, via a distributed network, a user's personal information;
output, via said distributed network, a graph indicating said user's estimated total savings over time;
receive, via the distributed network, a goal of said user and a date associated with said goal;
update, via a processor operatively coupled to said server, said graph based on said goal and said date associated with said goal;
output, via said distributed network, data associated with an unexpected event, said data comprising a predicted cost associated with the unexpected event;
update, via said processor, said graph based on said data associated with said unexpected event; and
output, via said distributed network, a risk management package recommended to protect said user against one or more unexpected risks.
